(19) United States
(12) Patent Application Publication
(10) Pub. No.: US 2025/0231637 A1
(43) Pub. Date: Jul. 17, 2025

(54) DISPLAY DEVICE

(71) Applicant: SAMSUNG DISPLAY CO., LTD., YONGIN-SI (KR)

(72) Inventor: SEULKI LEE, Yongin-si (KR)

(21) Appl. No.: 18/931,824

(22) Filed: Oct. 30, 2024

(30) Foreign Application Priority Data
Jan. 15, 2024 (KR) 10-2024-0006000

(51) Int. Cl. G06F 3/041

(52) U.S. Cl. CPC G06F 3/04164

(57) ABSTRACT

A display device includes a display panel and a circuit portion. The circuit portion includes a first circuit portion and a second circuit portion. The first circuit portion is connected to the display panel. The second circuit portion is connected to the display panel and at least partially overlaps the first circuit portion. A connection portion of the circuit portion that connects the first circuit portion and the second circuit portion is disposed between a rear surface of the display panel and the first circuit portion, and is covered by the first circuit portion.

### CROSS-REFERENCE TO RELATED APPLICATIONS

This application claims priority under 35 U.S.C. § 119 to Korean Patent Application No. 10-2024-0006000, filed on Jan. 15, 2024, the disclosure of which is incorporated by reference herein in its entirety.

### TECHNICAL FIELD

Embodiments of the present disclosure relate to a display device.

### DISCUSSION OF RELATED ART

Flat panel display devices include, for example, a liquid crystal display (LCD) device, a plasma display panel (PDP) display device, an organic light emitting diode (OLED) display device, a light emitting diode (LED) display device, a quantum dot LED (QLED) display device, a field effect display (FED) device, an electrophoretic display (EPD) device, etc.

In addition to displaying images, such display devices may include a touch sensing/detection function that allows interaction with a user via a touch input.

The touch sensing/detection function may detect changes in, for example, pressure, electric charge, and light applied to a display panel of the display device when the user touches the display panel with an object such as, for example, a finger or a touch pen. The touch sensing/detection function may determine whether an object has touched the display panel and the location of the touch, and the display device may receive an image signal based on this touch information.

### SUMMARY

Embodiments of the present disclosure provide a display device that can improve waterproof performance without the need for additional waterproofing layers.

According to an embodiment of the present disclosure, a display device includes a display panel, and a circuit portion including a first circuit portion and a second circuit portion. The first circuit portion is connected to the display panel. The second circuit portion is connected to the display panel and at least partially overlaps the first circuit portion. A connection portion of the circuit portion that connects the first circuit portion and the second circuit portion is disposed between the display panel and the first circuit portion, and is covered by the first circuit portion.

In an embodiment, the display panel includes a front surface on which an image is displayed and a rear surface opposite to the front surface. The first circuit portion and the second circuit portion are bent toward the rear of the display panel. The connection portion of the circuit portion may be disposed between the rear surface of the display panel and the first circuit portion.

In an embodiment, the display panel includes a plurality of pixels that display an image, and the first circuit portion transmits an image signal to the plurality of pixels.

In an embodiment, the second circuit portion detects a touch signal from the display panel.

In an embodiment, the second circuit portion includes a first portion connected to the display panel and a second portion connected to the first circuit portion, and the second portion of the second circuit portion includes a touch circuit portion.

In an embodiment, the first circuit portion includes a first surface and a second surface disposed opposite to each other, the first portion of the second circuit portion is disposed on the first surface of the first circuit portion, and the second portion of the second circuit portion is disposed on the second surface of the first circuit portion.

In an embodiment, the connection portion is disposed between the rear surface of the display panel and the second surface of the first circuit portion.

In an embodiment, the first circuit portion includes a hole, and the connection portion passes through the hole of the first circuit portion and connects the first portion of the second circuit portion and the second portion of the second circuit portion.

In an embodiment, the first circuit portion includes a groove portion, and the connection portion is inserted into the groove portion of the first circuit portion and connects the first portion of the second circuit portion and the second portion of the second circuit portion.

In an embodiment, the second circuit portion includes a first portion connected to the display panel, and a second portion and a third portion extended from the first portion, and the connection portion is disposed in the third portion.

In an embodiment, the second portion and the third portion may extend obliquely in different directions from the first portion and are spaced apart from each other.

In an embodiment, the first portion, the second portion, and the third portion are arranged along one direction and the second portion is disposed between the first portion and the third portion.

In an embodiment, the second portion has a curved shape.

### BRIEF DESCRIPTION OF THE DRAWINGS

The above and other features of the present disclosure will become more apparent by describing in detail embodiments thereof with reference to the accompanying drawings.

FIG. 1 is a plan view of a display device according to an embodiment of the present disclosure.

FIGS. 2 to 4 are cross-sectional views showing a portion of a display device according to an embodiment of the present disclosure.

FIG. 5 is a plan view illustrating a partial area of the back of a display panel of a display device according to an embodiment of the present disclosure.

FIG. 6 is a plan view showing the rear of a partial area of FIG. 5 according to an embodiment of the present disclosure.

FIG. 7 is a plan view illustrating a portion of a display device according to an embodiment of the present disclosure.

FIG. 8 is a plan view illustrating a portion of a display device according to an embodiment of the present disclosure.

FIG. 9 is a plan view showing a portion of a display device according to an embodiment of the present disclosure.

FIG. 10 is a plan view illustrating a portion of a display device according to an embodiment of the present disclosure.

### DETAILED DESCRIPTION

Embodiments of the present disclosure will be described more fully hereinafter with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

Spatially relative terms, such as “beneath”, “below”, “lower”, “under”, “above”, “upper”, etc., may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below.

It will be understood that when a component such as a film, a region, a layer, etc., is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. It will also be understood that when a component is referred to as “covering” another component, it can be the only component covering the other component, or one or more intervening components may also be covering the other component. Other words used to describe the relationships between components should be interpreted in a like fashion.

Embodiments of the present disclosure provide a display device having a structural arrangement including first and second circuit portions within a display panel that may improve waterproof performance without the need for additional configurations or protective layers. According to embodiments, an image circuit portion (also referred to as a first circuit portion), which may be used to transmit image signals, and a touch circuit portion (also referred to as a second circuit portion), which may be used to transmit and receive touch signals, may be configured to partially overlap. An area where the image circuit portion and the touch circuit portion are connected to each other may be referred to as a connection portion, and may be disposed between the display panel and the first circuit portion, for example, in a direction perpendicular to the display panel's surface. By bending the image circuit portion and the touch circuit portion toward the rear of the display panel, the connection may be effectively shielded between the rear surface of the display panel and the image circuit portion.

The above-described arrangement may protect the connection from environmental exposure, which may improve waterproof performance, and may also eliminate the need for additional waterproofing layers. Additionally, embodiments may include holes or grooves in the image circuit portion through which the touch circuit portion passes, which may further secure the connection and improve the overall durability of the display device. The integration of the touch circuit portion with the image circuit portion may result in the touch signals being accurately processed while being safeguarded from external elements such as, for example, water and static electricity, which may improve the durability and reliability of the device.

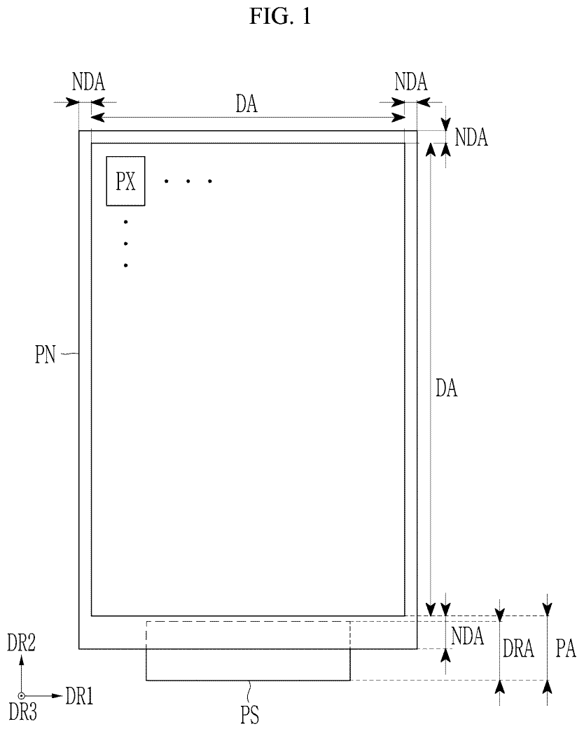

With reference to FIGS. 1 to 5, a display device according to an embodiment will be described.

FIG. 1 is a plan view of a display device according to an embodiment of the present disclosure.

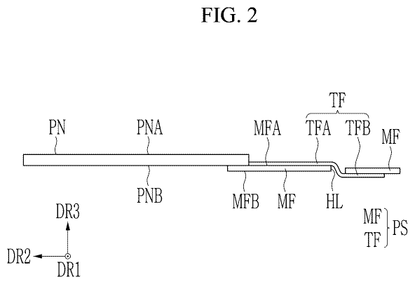

FIGS. 2 to 4 are cross-sectional views showing a portion of a display device according to an embodiment of the present disclosure.

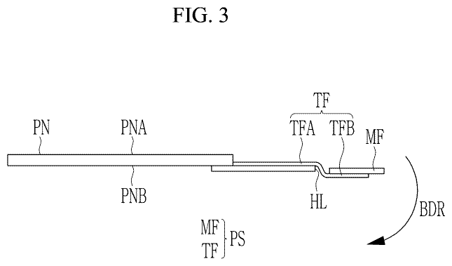

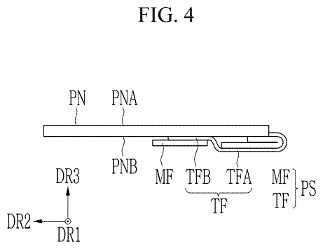

FIG. 2 shows a state before assembling a display device according to an embodiment, FIG. 3 shows an operation of assembling a display device according to an embodiment, and FIG. 4 shows a state after assembling a display device according to an embodiment.

Referring to FIG. 1, a display device according to an embodiment may include a display panel PN, which includes a display area DA in which a plurality of pixels PX is arranged in a first direction DR1 and a second direction DR2 and in which an image is displayed, and a non-display area NDA surrounding the display area DA in which an image is not displayed.

A driving area DRA including a circuit portion PS connected to the display panel PN and bent to the rear of the display panel PN is disposed at the outer periphery of a portion of the non-display area NDA of the display panel PN. The circuit portion PS refers to a component on which a circuit, for example, an electrical circuit, which may include electrical circuit components such as, for example, transistors, resistors, capacitors, etc., is disposed. The electrical circuit including electrical circuit components may be disposed on, for example, a printed circuit board (PCB), a flexible printed circuit board (FPCB), etc. According to embodiments, the circuit portion PS may include an image circuit portion MF (also referred to as a first circuit portion) and a touch circuit portion TF.

A connection portion may refer to a part(s) of both the image circuit portion MF and the touch circuit portion TF that physically and electrically connects the image circuit portion MF and the touch circuit portion TF to each other. The connection portion may be formed, for example, when the touch circuit portion TF is pressed and bonded to the image circuit portion MF, which is described in further detail below. The connection portion may be disposed between a rear surface of the display panel PN and the image circuit portion MF, and may cover and protect the image circuit portion MF. Further, the connection portion may pass through a hole formed in the image circuit portion MF, or may be inserted into a groove portion of the image circuit portion MF, as described in further detail below.

The non-display area NDA and the driving area DRA disposed at the outer periphery of the display area DA may form a peripheral area PA.

The display area DA may include a plurality of display signal lines that transmit driving signals that drive the plurality of pixels PX.

The display signal lines may include a gate line that transmits a gate signal and a data line that transmits a data signal.

The display area DA may include a touch active area, and the touch active area may include a touch sensing layer.

The touch sensing layer may include a touch electrode and a touch signal line that transmits and/or receives a signal to the touch electrode.

The touch active area may be the entire display area DA or may include a portion of the peripheral area PA.

Additionally, a portion of the display area DA may be a touch active area.

The touch detection layer can detect touch using various methods. For example, the touch detection sensor may employ resistive, capacitive, electromagnetic (EM), or optical types of sensing.

The driving area DRA may be disposed below the non-display area NDA of the display panel PN along the second direction DR2. However, embodiments of the present disclosure are not limited thereto.

As described above, the circuit portion PS may include a connection portion connected to the display panel PN and a curved portion curved from the connection portion to the back of the display panel PN.

Referring to FIGS. 2 to 4 along with FIG. 1, the circuit portion PS disposed in the driving area DRA may include the image circuit portion MF that supplies image signals to the plurality of pixels PX disposed in the display panel PN to display an image, and the touch circuit portion TF that transmits touch detection signals to the display panel PN.

The image circuit portion MF may transmit driving signals to a plurality of display signal lines connected to the plurality of pixels PX, and the touch circuit portion TF may transmit detection input signals to the touch sensing layer.

The touch circuit portion TF may process the output signals from the touch sensing layer to generate touch information, such as whether a touch has occurred and the location of the touch.

Referring to FIG. 2, the display panel PN may include a front surface PNA that displays images using a plurality of pixels PX and a rear surface PNB opposite to the front surface PNA.

The front surface PNA and the rear surface PNB of the display panel PN may be disposed opposite to each other along the third direction DR3, which is perpendicular to the first direction DR1 and the second direction DR2.

A circuit portion PS may be connected to the rear surface PNB of the display panel PN.

The image circuit portion MF of the circuit portion PS may include a first surface MFA and a second surface MFB disposed opposite to each other.

The touch circuit portion TF of the circuit portion PS may include a first portion TFA that is connected to the display panel PN and disposed on the first side MFA of the image circuit portion MF, and a second portion TFB that is connected to the first portion TFA and disposed above the second surface MFB. The second portion TFB is connected to the image circuit portion MF. The second portion TFB of the touch circuit portion TF may include a touch circuit portion that transmits a signal that detects a touch signal of the display panel PN.

The image circuit portion MF of the circuit portion PS may include a hole HL, and a connection portion between the first portion TFA and the second portion TFB of the touch circuit portion TF may pass through the hole HL of the image circuit portion MF.

The second portion TFB of the touch circuit portion TF and the second surface MFB of the image circuit portion MF are pressed and bonded to each other so that a circuit portion disposed in the second portion TFB of the touch circuit portion TF may be connected to the image circuit portion MF.

Referring to FIG. 3, in the assembly operation of the display device according to an embodiment, the image circuit portion MF and the touch circuit portion TF of the circuit portion PS may be bent in the bending direction BDR.

Referring to FIG. 4, the image circuit portion MF and the touch circuit portion TF of the circuit portion PS may be bent in the bending direction BDR and attached to the rear surface PNB of the display panel PN.

The touch circuit portion disposed in the second portion TFB of the touch circuit portion TF may be connected to the image circuit portion MF through a pressing process.

For example, the touch circuit portion TF may be pressed and bonded to the image circuit portion MF by pressing the touch circuit portion TF at a high temperature and pressure using an anisotropic conductive film.

The pressed and bonded portion of the second portion TFB of the touch circuit portion TF connected to the image circuit portion MF may be disposed between the rear surface PNB of the display panel PN and the image circuit portion MF.

Accordingly, the pressed and bonded portion between the image circuit portion MF and the second portion TFB of the touch circuit portion TF may be covered and protected by the image circuit portion MF.

Therefore, waterproofing performance can be maintained without adding an additional waterproofing layer.

Additionally, the press and bonded portion of the touch circuit portion TF can be protected from external static electricity.

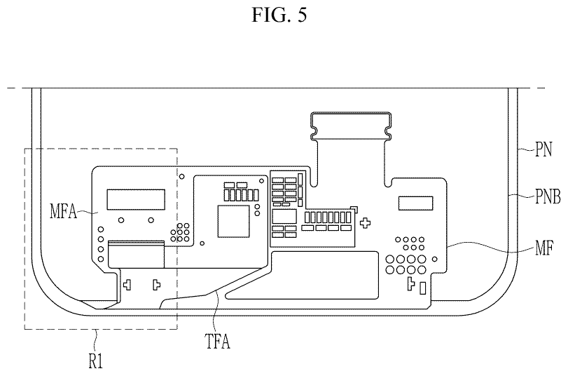

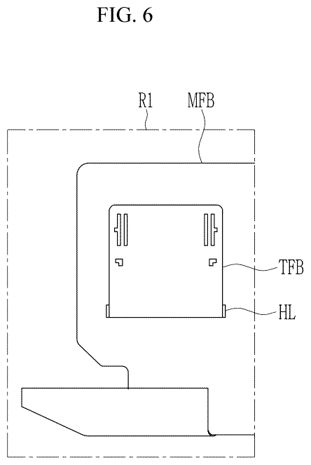

Referring to FIGS. 5 and 6 along with FIGS. 1 to 4, the circuit portion PS disposed on the rear surface PNB of the display panel PN will be described below in more detail.

FIG. 5 is a plan view showing a partial rear area of a display panel of a display device according to an embodiment of the present disclosure, and FIG. 6 is a plan view showing a rear partial area of FIG. 5 according to an embodiment of the present disclosure.

Referring to FIG. 5, the image circuit portion MF of the bent circuit portion PS may be disposed on the rear surface PNB of the display panel PN.

The first portion TFA of the touch circuit portion TF may be disposed on the first surface MFA of the image circuit portion MF.

Referring to FIG. 6, which shows the rear partial area R1 of FIG. 5, the image circuit portion MF has a hole HL, and the touch circuit portion TF can pass through the hole HL.

The second portion TFB of the touch circuit portion TF may be pressed and bonded to the second surface MFB of the image circuit portion MF.

The circuit portion of the touch circuit portion TF may be disposed in the second portion TFB.

Accordingly, the circuit portion of the touch circuit portion TF may be disposed between the rear surface PNB of the display panel PN and the image circuit portion MF.

Accordingly, the pressed and bonded portion between the image circuit portion MF and the second portion TFB of the touch circuit portion TF may be covered and protected by the image circuit portion MF.

Therefore, waterproofing performance can be maintained without adding an additional waterproofing layer.

Additionally, the press connection portion of the touch circuit portion TF can be protected from external static electricity.

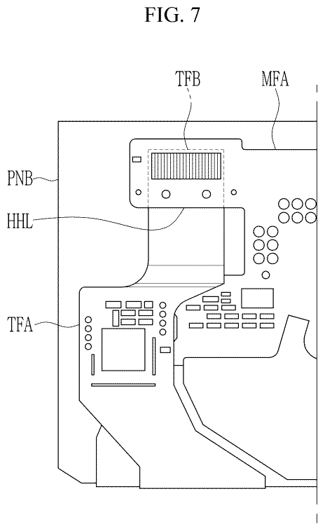

FIG. 7 is a plan view illustrating a portion of a display device according to an embodiment of the present disclosure.

An embodiment of the display device described with reference to FIG. 7 is similar to an embodiment of the display device described with reference to FIGS. 1 to 6. For convenience of explanation, a further description of components and technical details previously described will be omitted.

Referring to FIG. 7, in the display device according to an embodiment of the present disclosure, similar to the display device according to an embodiment described with reference to FIGS. 1 to 6, the image circuit portion MF and the touch circuit portion TF of the circuit portion PS are bent and attached to the rear PNB side of the display panel PN.

However, unlike an embodiment of the display device described with reference to FIGS. 1 to 6, the image circuit portion MF of the display device according to an embodiment described with reference to FIG. 7 has a groove portion HHL rather than a hole HL, and the touch circuit portion TF passes through the groove portion HHL while being inserted into the groove portion HHL so that the second portion TFB of the touch circuit portion TF may be disposed behind the image circuit portion MF.

The first portion TFA of the touch circuitry TF may be disposed on the first side MFA of the image circuitry MF, and the second portion TFB of the touch circuitry TF may be disposed on the first side TFA of the image circuitry MF, and it may be attached by being pressed to the second side MFB opposite the first side MFA.

For example, the first portion TFA of the touch circuitry TF may be disposed on the first side MFA of the image circuitry MF, while the second portion TFB of the touch circuitry TF may be disposed on the opposite side TFA of the image circuitry MF. The second portion TFB may then be attached by pressing it onto the second side MFB, which is opposite the first side MFA.

The circuit portion of the touch circuit portion TF may be disposed in the second portion TFB.

Accordingly, the circuit portion of the touch circuit portion TF may be disposed between the rear surface PNB of the display panel PN and the image circuit portion MF.

Accordingly, the pressed and bonded connection portion between the image circuit portion MF and the second portion TFB of the touch circuit portion TF may be covered and protected by the image circuit portion MF.

Therefore, waterproofing performance can be maintained without adding an additional waterproofing layer.

Additionally, the press connection portion of the touch circuit portion TF can be protected from external static electricity.

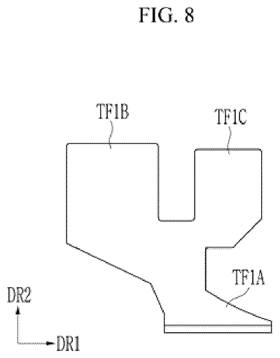

The form of the touch circuit portion according to an embodiment of the present disclosure will be described below with reference to FIG. 8. For convenience of explanation, a further description of components and technical aspects previously described will be omitted.

FIG. 8 is a plan view illustrating a portion of a display device according to an embodiment of the present disclosure.

Referring to FIG. 8, the touch circuit portion TF1 according to an embodiment includes a first portion TF1A connected to the display panel PN, and a second portion TF1B and a third portion TF1C extending obliquely from the first portion TF1A along different directions.

For example, the touch circuit portion TF1 may have a planar shape similar to the letter Y of the alphabet.

A pressed and bonded connection portion of the touch circuit portion TF1 may be disposed in the third portion TF1C of the touch circuit portion TF1.

As described above, the image circuit portion MF may have a hole HL or a groove HHL, and the third portion TF1C of the touch circuit portion TF1 may pass through the hole HL or the groove portion of the image circuit portion MF and be disposed behind the image circuit portion MF.

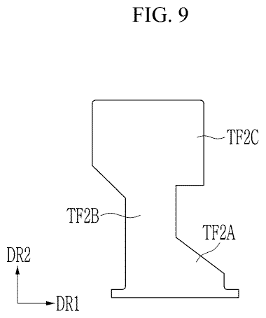

The form of a touch circuit portion according to an embodiment of the present disclosure will be described below with reference to FIG. 9. For convenience of explanation, a further description of components and technical aspects previously described will be omitted.

FIG. 9 is a plan view illustrating a portion of a display device according to an embodiment of the present disclosure.

Referring to FIG. 9, the touch circuit portion TF2 according to an embodiment includes a first portion TF2A connected to the display panel PN, and a second portion TF2B and a third portion TF2C sequentially extending from the first portion TF2A along the second direction DR2.

Along the first direction DR1, the width of the second portion TF2B may be narrower than the widths of the first portion TF2A and the third portion TF2C.

For example, the touch circuit portion TF2 may have a planar shape similar to the letter I of the alphabet.

A pressed and bonded connection portion of the touch circuit portion TF2 may be disposed in the third portion TF2C of the touch circuit portion TF2.

As described above, the image circuit portion MF may have a hole HL or a groove HHL, and the third portion TF2C of the touch circuit portion TF2 may pass through the hole HL or the groove portion of the image circuit portion MF and be disposed behind the image circuit portion MF.

The form of a touch circuit portion according to an embodiment of the present disclosure will be described. For convenience of explanation, a further description of components and technical aspects previously described will be omitted.

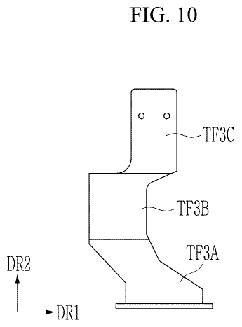

FIG. 10 is a plan view illustrating a portion of a display device according to an embodiment of the present disclosure.

Referring to FIG. 10, the touch circuit portion TF3 according to an embodiment includes a first portion TF3A connected to the display panel PN, and a second portion TF3B and a third portion TF3C sequentially extended from the first portion TF3A along the second direction DR2.

The second portion TF3B may include a curved portion at the connection portion between the second portion TF3B and the first portion TF3A and at the connection portion between the second portion TF3B and the third portion TF3C.

For example, the touch circuit portion TF3 may have a planar shape similar to the letter C.

A pressed and bonded connection portion of the touch circuit portion TF3 may be disposed in the third portion TF3C of the touch circuit portion TF3.

As described above, the image circuit portion MF may have a hole HL or a groove HHL, and the third portion TF3C of the touch circuit portion TF3 may pass through the hole HL or the groove portion of the image circuit portion MF and be disposed behind the video circuit portion MF.

While the present disclosure has been particularly shown and described with reference to embodiments thereof, it will be understood by those of ordinary skill in the art that various changes in form and detail may be made therein without departing from the spirit and scope of the present disclosure as defined by the following claims.

What is claimed is:

1. A display device, comprising:
a display panel; and
a circuit portion including a first circuit portion and a second circuit portion,
wherein the first circuit portion is connected to the display panel,
the second circuit portion is connected to the display panel and at least partially overlaps the first circuit portion, and
a connection portion of the circuit portion that connects the first circuit portion and the second circuit portion is disposed between the display panel and the first circuit portion, and is covered by the first circuit portion.

2. The display device of claim 1, wherein
the display panel includes a front surface on which an image is displayed and a rear surface opposite to the front surface,
the first circuit portion and the second circuit portion are bent toward the rear surface of the display panel, and
the connection portion of the circuit portion is disposed between the rear surface of the display panel and the first circuit portion.

3. The display device of claim 1, wherein
the display panel includes a plurality of pixels that display an image, and
the first circuit portion transmits an image signal to the plurality of pixels.

4. The display device of claim 3, wherein
the second circuit portion transmits a signal that detects a touch signal of the display panel.

5. The display device of claim 4, wherein
the second circuit portion includes a first portion connected to the display panel and a second portion connected to the first circuit portion, and
the second portion of the second circuit portion includes a touch circuit portion.

6. The display device of claim 5, wherein
the first circuit portion includes a first surface and a second surface disposed opposite to each other,
the first portion of the second circuit portion is disposed on the first surface of the first circuit portion, and
the second portion of the second circuit portion is disposed on the second surface of the first circuit portion.

7. The display device of claim 6, wherein
the connection portion is disposed between the rear surface of the display panel and the second surface of the first circuit portion.

8. The display device of claim 6, wherein
the first circuit portion includes a hole, and
the connection portion passes through the hole of the first circuit portion and connects the first portion of the second circuit portion and the second portion of the second circuit portion.

9. The display device of claim 6, wherein
the first circuit portion includes a groove portion, and
the connection portion is inserted into the groove portion of the first circuit portion and connects the first portion of the second circuit portion and the second portion of the second circuit portion.

10. The display device of claim 4, wherein
the second circuit portion includes a first portion connected to the display panel, and a second portion and a third portion extended from the first portion, and
the connection portion is disposed in the third portion.

11. The display device of claim 10, wherein
the second portion and the third portion extend obliquely in different directions from the first portion and are spaced apart from each other.

12. The display device of claim 10, wherein
the first portion, the second portion, and the third portion are arranged along one direction, and the second portion is disposed between the first portion and the third portion.

13. The display device of claim 12, wherein
the second portion has a curved shape.

14. The display device of claim 1, wherein
the second circuit portion includes a first portion connected to the display panel and a second portion connected to the first circuit portion, and
the second portion of the second circuit portion includes a touch circuit portion.

15. The display device of claim 14, wherein
the first circuit portion includes a first surface and a second surface disposed opposite to each other,
the first portion of the second circuit portion is disposed on the first surface of the first circuit portion, and
the second portion of the second circuit portion is disposed on the second surface of the first circuit portion.

16. The display device of claim 15, wherein
the connection portion is disposed between the rear surface of the display panel and the second surface of the first circuit portion.

17. The display device of claim 15, wherein
the first circuit portion includes a hole, and
the connection portion passes through the hole of the first circuit portion and connects the first portion of the second circuit portion and the second portion of the second circuit portion.

18. The display device of claim 15, wherein
the first circuit portion includes a groove portion, and
the connection portion is inserted into the groove portion of the first circuit portion and connects the first portion of the second circuit portion and the second portion of the second circuit portion.

19. The display device of claim 1, wherein
the second circuit portion includes a first portion connected to the display panel and a second portion connected to the first circuit portion,
the first circuit portion includes a hole, and
the connection portion passes through the hole of the first circuit portion and connects the first portion of the second circuit portion and the second portion of the second circuit portion.

20. The display device of claim 1, wherein
the second circuit portion includes a first portion connected to the display panel and a second portion connected to the first circuit portion,
the first circuit portion includes a groove portion, and
the connection portion is inserted into the groove portion of the first circuit portion and connects the first portion of the second circuit portion and the second portion of the second circuit portion.
